(19) United States
(12) Patent Application Publication
(10) Pub. No.: US 2004/0241453 A1
(43) Pub. Date: Dec. 2, 2004

(54) Electron beam curing resin for magnetic recording medium, method for manufacturing the same, and magnetic recording medium including the same

(75) Inventors: Hideki Sasaki, Tokyo (JP); Shigeo Kurose, Tokyo (JP); Hiroyuki Tanaka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/855,593

(22) Filed: May 28, 2004

(30) Foreign Application Priority Data
May 28, 2003 (JP) 2003-150217

(51) Int. Cl. B32B 9/00

(52) U.S. Cl. 428/423.1; 428/692

(57) ABSTRACT

An electron beam curing resin for a magnetic recording medium is provided, wherein a known thermosetting vinyl chloride resin or polyurethane resin is modified to become sensitive to an electron beam while an increase in viscosity and gelation of a paint are prevented, and the resulting resin has a high cross-linking property. A method for readily manufacturing the above-described electron beam curing resin from a known thermosetting resin is provided. Furthermore, a high-performance magnetic recording medium including the above-described electron beam curing resin is provided. The electron beam curing resin is produced through a reaction between DI-HA adducts and active hydrogen groups of a vinyl chloride resin or polyurethane resin having the active hydrogen groups in a molecule, wherein the DI-HA adduct is produced through a reaction between a diisocyanate (DI) and a hydoxy(meth)acrylate compound (HA) at an HA/DI molar ratio of more than 1 and less than 2.

### BACKGROUND OF THE INVENTION

1. Field of the Invention

The present invention relates to an electron beam curing resin for a magnetic recording medium, a method for manufacturing the same, and a magnetic recording medium including the same. In particular, it relates to an electron beam curing resin having a high cross-linking property suitable for the magnetic recording medium use, a method for manufacturing the same, in which an electron beam curing resin having a high cross-linking property is produced by modifying a general thermosetting vinyl chloride resin or polyurethane resin to become sensitive to an electron beam, and a magnetic recording medium including the same.

2. Description of the Related Art

Known resins used for magnetic recording media primarily include thermosetting resins and electron beam curing resins. Among them, the thermosetting resin is cured by a method in which active hydrogen groups typified by a hydroxyl group present in the resin and isocyanate compounds are reacted so as to effect cross-linking of the resin. On the other hand, the electron beam curing resin is cured by a method in which electron beam sensitive type functional groups typified by an acrylic double bond are introduced in a molecule of the resin, and cross-linking of the resin is effected by electron beam irradiation.

In general, electron beam curing resins used for magnetic recording media include vinyl chloride resins and polyurethane resins. Examples of methods for modifying the vinyl chloride resins to become sensitive to an electron beam include a method in which hydroxyl groups in a thermosetting vinyl chloride resin having the hydroxyl groups are reacted with tolylene diisocyanate (TDI) adducts resulting from a reaction between TDI and 2-hydroxyethyl methacrylate (2-HEMA), as disclosed in Japanese Examined Patent Application Publication No. 1-25141, a method in which hydroxyl groups in a vinyl chloride resin are reacted with cyclic acid anhydrides and, furthermore, an epoxy monomer having an acrylic double bond is reacted, as disclosed in Japanese Patent No. 2514682, and a method in which hydroxyl groups in a vinyl chloride resin are reacted with 2-isocyanate ethyl (meth)acrylate (MOI), as disclosed in Japanese Unexamined Patent Application Publication No. 4-67314.

On the other hand, with respect to the polyurethane resin, typical examples of methods include a method in which a (meth)acrylate compound having hydroxyl groups in a molecule is used as a part of the raw materials for synthesizing the polyurethane and, thereby, a radiation curing polyurethane resin is produced, as disclosed in Japanese Patent No. 2610468 and a method in which a polyurethane having isocyanate groups at polymer terminals is prepared and, subsequently, is reacted with alcohol having an acrylic double bond, as disclosed in Japanese Examined Patent Application Publication No. 3-1727.

In order to produce a radiation curing resin having excellent curability and the like, a method for manufacturing a radiation curing resin is described in Japanese Unexamined Patent Application Publication No. 1-81812. This method includes the step of reacting a predetermined monohydroxy compound and a diisocyanate compound in a predetermined proportion.

However, with respect to known electron beam sensitive modified materials of vinyl chloride resins or polyurethane resins, coating films do not always have adequate cross-linking properties. The methods disclosed in the above-described Japanese Examined Patent Application Publication No. 1-25141 and Japanese Patent No. 2514682 have problems in that gelation of resins and paints occur and, thereby, the dispersibility is reduced. Furthermore, if the concentration of hydroxyl groups in the resin is increased in order to improve the cross-linking property, a problem occurs in that the viscosity of the paint is increased.

### SUMMARY OF THE INVENTION

Accordingly, it is an object of the present invention to provide an electron beam curing resin for a magnetic recording medium, wherein a known thermosetting vinyl chloride resin or polyurethane resin is modified to become sensitive to the electron beam while an increase in viscosity and gelation of a paint are prevented and, thereby, the resulting resin has a high cross-linking property suitable for the magnetic recording medium use. It is another object of the present invention to provide a method for manufacturing the above-described electron beam curing resin, wherein the electron beam curing resin having a high cross-linking property can readily be produced from a known thermosetting resin. Furthermore, it is another object of the present invention to provide a high-performance magnetic recording medium through the use of the above-described electron beam curing resin.

In order to overcome the above-described problems, the inventors of the present invention conducted intensive research, and found out that an electron beam curing resin having a high cross-linking property and stability was able to be produced through modification to an electron beam curing type by reacting active hydrogen groups of a vinyl chloride resin or polyurethane resin having the active hydrogen groups in a molecule with DI-HA adducts, wherein the DI-HA adduct was a product resulting from a reaction between a diisocyanate (DI) and a hydoxy(meth)acrylate compound (HA) at an HA/DI molar ratio within a predetermined range. Consequently, the present invention has been made.

An electron beam curing resin for a magnetic recording medium of the present invention is a product resulting from a reaction between DI-HA adducts and active hydrogen groups of a vinyl chloride resin or polyurethane resin having the active hydrogen groups in a molecule, wherein the DI-HA adduct is a product resulting from a reaction between a diisocyanate (DI) and a hydoxy(meth)acrylate compound (HA) at an HA/DI molar ratio of more than 1 and less than 2. Preferably, the above-described diisocyanate (DI) is isophorone diisocyanate (IPDI).

A method for manufacturing an electron beam curing resin for a magnetic recording medium of the present invention includes the steps of reacting a diisocyanate (DI) and a hydoxy(meth)acrylate compound (HA) at an HA/DI molar ratio of more than 1 and less than 2 and, subsequently, reacting the resulting DI-HA adduct and a vinyl chloride resin or polyurethane resin having active hydrogen groups in a molecule.

A magnetic recording medium of the present invention is provided with a layer containing the above-described electron beam curing resin for a magnetic recording medium on a non-magnetic support.

According to the present invention, an electron beam curing resin for a magnetic recording medium can be produced while having an excellent cross-linking property and dispersibility, wherein a known vinyl chloride resin or polyurethane resin having active hydrogen groups is used as a raw material, and an increase in viscosity and gelation of a paint are prevented. Consequently, a high-performance magnetic recording medium can be produced.

### DESCRIPTION OF THE PREFERRED EMBODIMENTS

Specific embodiments of the present invention will be described below.

An electron beam curing resin for a magnetic recording medium of the present invention is produced by modifying a vinyl chloride resin or polyurethane resin serving as a raw material to become sensitive to an electron beam through the use of a specific DI-HA adduct.

The vinyl chloride resin or the polyurethane resin used as a raw material in the present invention may be a known (general-purpose) resin or a novel resin. However, the resin must have active hydrogen groups, e.g., hydroxyl groups, primary amines, or secondary amines, in a molecule in order to effect the reaction.

Such a resin is not specifically limited. Specific examples of vinyl chloride resins include MR110, MR104, MR112, MR113 (produced by ZEON Corporation), SOLBIN A, SOLBIN TAO, and SOLBIN MK6 (produced by Nisshin Chemical Industry Co., Ltd.). Examples of polyurethane resins include Estane 5778P, Estane 5799P (produced by BF GOODRICH), UR8700, UR8300 (produced by Toyobo Co., Ltd.), N-3167, N-3301, and TK501K (produced by NIPPON POLYURETHANE INDUSTRY CO., LTD.).

The DI-HA adduct is a compound for being reacted with active hydrogen in the resin in order that the resin is modified to become sensitive to an electron beam, and is a product resulting from a reaction between a diisocyanate (DI) and a hydoxy(meth)acrylate compound (HA). In the present invention, it is important that the diisocyanate (DI) and the hydoxy(meth)acrylate compound (HA) are reacted at an HA/DI molar ratio of more than 1 and less than 2. Preferably, this HA/DI molar ratio is 1.2 or more and less than 2, and more preferably is 1.3 or more and less than 2. The HA/DI molar ratio in the reaction between the diisocyanate (DI) and the hydoxy(meth)acrylate compound (HA) is controlled at within the above-described range and, thereby, an increase in viscosity and gelation of a paint can be effectively prevented.

On the other hand, if the DI-HA adduct is produced at a compounding ratio described in Japanese Examined Patent Application Publication No. 1-25141, while this ratio is out of the HA/DI molar ratio in the present invention, large amounts of unreacted diisocyanate remain in the reaction system. Consequently, when the resulting adduct is reacted with the resin, the viscosity of the resin solution resulting from the reaction is increased and, by extension, gelation occurs. Since the reaction is not advanced smoothly, the cross-linking property of the resin coating is reduced. If a pigment is dispersed through the use of such a resin, the dispersibility is reduced, and the solvent resistance of the coating film is reduced. Furthermore, in a technology described in Japanese Examined Patent Application Publication No. 1-81812, a monohydroxy compound and a diisocyanate compound are reacted in a proportion substantially corresponding to the above-described reaction molar ratio of less than 2.0 in a reaction for producing an adduct. In this technology as well, since unreacted diisocyanate compounds remain after the reaction is completed, a step for removing them is indispensable. Consequently, this technology has an effect significantly different from that in the present invention, because no unreacted diisocyanate compound remains in the present invention and, therefore, the step of removing the unreacted diisocyanate is unnecessary. In the example of Japanese Examined Patent Application Publication No. 1-81812, only a manufacturing example of a resin at a reaction molar ratio of 1.0 is described, although this reaction molar ratio is out of the range of the present invention.

Examples of diisocyanates (DI) used as a raw material for such an adduct may include isophorone diisocyanate (IPDI), 2,4-toluene diisocyanate (2,4-TDI), 2,6-toluene diisocyanate (2,6-TDI), 1,4-xylene diisocyanate, hexamethylene diisocyanate, and paraphenylene diisocyanate. Among them, preferably, isophorone diisocyanate (IPDI) is used because the crystallinity of the adduct is low, and the following modification advances smoothly. With respect to other diisocyanates, the crystallinity of the adduct becomes high, the solubility into the reaction system is reduced and, thereby, the reaction does not advance smoothly, so that the viscosity tends to slightly increase. As a result, the dispersibility is slightly reduced.

The hydroxyacrylate compound (HA) is another raw material for the adduct, and is not specifically limited. Specific example thereof include 2-hydroxyethyl acrylate (2-HEA), 2-hydroxyethyl methacrylate (2-HEMA), 2-hydroxypropyl acrylate, hydroxydiethylene glycol methacrylate, butoxyhydroxypropyl acrylate, phenoxyhydroxypropyl acrylate, hydroxypropyl dimethacrylate, glycidol dimethacrylate, glycerol dimethacrylate, and monohydroxypentaerythritol triacrylate.

The DI-HA adduct and active hydrogen in a vinyl chloride resin or a polyurethane resin are reacted and, thereby, the resin is modified to become sensitive to an electron beam. The reaction is performed in an organic solvent, e.g., methyl ethyl ketone (MEK) or toluene. In this reaction, preferably, the synthesis is usually effected through the use of 0.005 to 0.1 parts by mass of urethane catalyst, e.g., dibutyltin dilaurate or tin octylate, relative to 100 parts by mass of the total amount of reactants. Preferably, the reaction temperature is 30° C. to 80° C., and more preferably is 50° C. to 70° C.

The thus produced electron beam curing resins can be used as binders of resin undercoat layers, undercoat layers containing inorganic pigments, back coating layers, and magnetic layers in magnetic recording media. Hereafter these layers may be collectively referred to as “functional layers”. The electron beam curing resin may be used alone, or in the form of a mixture with other resins typified by a polyurethane resin.

Preferably, the amount of irradiation in cross-linking of the electron beam curing resin of the present invention by the use of an electron beam is 1 to 10 Mrad, and more preferably is 3 to 7 Mrad. Preferably, the irradiation energy (acceleration voltage) is at least 100 kV.

In the present invention, the above-described electron beam curing resin is used as a binder of the functional layer and, thereby, a high-performance magnetic recording medium provided with a functional layer having a high cross-linking property and excellent solvent resistance can be produced. It is only essential that the magnetic recording medium of the present invention is provided with a layer containing the above-described electron beam curing resin of the present invention on a non-magnetic support, and other constituent materials, additives, and the like are not specifically limited. For example, the following materials may be used.

The non-magnetic support may be appropriately selected from known resin films, e.g., polyesters, polyamides, and aromatic polyamides, and resin films composed of laminates of them. The thickness thereof and the like may be within known ranges, and are not specifically limited.

A ferromagnetic powder used for the magnetic layer is an acicular ferromagnetic metal powder preferably having an average major-axis length of 0.15 μm or less, and more preferably of 0.03 to 0.10 μm. If the average major-axis length exceeds 0.15 μm, it tends to become difficult to adequately satisfy the electromagnetic conversion characteristic (in particular the SIN characteristic and the C/N characteristic) required of the magnetic recording medium. A hexagonal iron oxide powder, e.g., barium ferrite, may be used as well. Preferably, the plate ratio of the hexagonal iron oxide powder is 2 to 7. Preferably, the average primary plate diameter determined by TEM observation is 10 to 50 nm. If larger than this, the surface of the magnetic layer tends to become deteriorated.

It is essential that the content of the above-described ferromagnetic powder in the magnetic layer composition is about 70 to 90 percent by mass. If the content of the ferromagnetic powder is too large, the content of the binder is decreased and, thereby, the surface smoothness resulting from calendering tends to become deteriorated. On the other hand, if too small, a high playback output is not readily achieved.

A binder resin for the magnetic layer is not specifically limited and, besides the above-described electron beam curing resins of the present invention, previously known thermoplastic resins, thermosetting resins, other radiation curing resins, and mixtures thereof may be suitable for the binder resin.

Preferably, the content of the binder resin used for the magnetic layer is 5 to 40 parts by mass relative to 100 parts by mass of the ferromagnetic powder, in particular is 10 to 30 parts by mass. If the content of the binder resin is too small, the strength of the magnetic layer is reduced and, thereby, the running durability tends to become deteriorated. On the other hand, if the content is too large, the content of the ferromagnetic metal powder is reduced and, thereby, the electromagnetic conversion characteristic becomes deteriorated.

Examples of cross-linking agents for curing these binder resins may include various known polyisocyanates in the case of thermosetting resins. Preferably, the content of this cross-linking agent is 10 to 30 parts by mass relative to 100 parts by mass of the binder resin. If necessary, an abrasive, a dispersing agent, e.g., a surfactant, a higher aliphatic acid, and other various additives may be added to the magnetic layer.

A paint for forming the magnetic layer is prepared by adding an organic solvent to the above-described components. The organic solvent to be used is not specifically limited, and at least one solvent may be appropriately selected from various solvents, for example, ketone solvents, e.g., methyl ethyl ketone (MEK), methyl isobutyl ketone, and cyclohexanone; and aromatic solvents, e.g., toluene. The amount of addition of the organic solvent may be about 100 to 1,100 parts by mass relative to 100 parts by mass of the total amount of the solid (the ferromagnetic metal powder, various inorganic particles, and the like) and the binder resin.

The thickness of the magnetic layer in the present invention is controlled at 3.0 μm or less, preferably at 0.01 to 0.50 μm, and more preferably at 0.02 to 0.30 μm. If the magnetic layer is too thick, the self-demagnetization loss and the thickness loss are increased.

A non-magnetic layer serving as the above-described undercoat layer may be provided between the magnetic layer and the non-magnetic support and, thereby, the electromagnetic conversion characteristic of the thin magnetic layer is improved, so that the reliability is further increased.

Various inorganic powders may be used as the non-magnetic powder used for the non-magnetic layer. Preferable examples thereof may include acicular non-magnetic powders, e.g., acicular non-magnetic iron oxide (α-Fe₂O₃). Other non-magnetic powders, e.g., calcium carbonate (CaCO₃), titanium oxide (TiO₂), barium sulfate (BaSO₄), and α-alumina (α-Al₂O₃), may be appropriately compounded. Preferably, carbon black is used for the non-magnetic layer. Examples of the above-described carbon black may include furnace black for rubber, thermal black for rubber, black for a color, and acetylene black.

Preferably, the compounding ratio of the carbon black to the inorganic powder is 100/0 to 10/90 on a weight ratio basis. If the compounding ratio of the inorganic powder exceeds 90, a problem of surface electric resistance tends to occur.

With respect to a binder resin for the non-magnetic layer, besides the above-described electron beam curing resins of the present invention, previously known thermoplastic resins, thermosetting resins, other radiation curing resins, and mixtures thereof may be used in a manner similar to that in the magnetic layer. Among them, the radiation curing resins are preferable.

If necessary, a dispersing agent, e.g., a surfactant; a higher aliphatic acid; a lubricant, e.g., an aliphatic ester, silicone oil or the like; and other various additives, which are used in the magnetic layer, may be further added to the non-magnetic layer of the present invention. A paint for the non-magnetic layer may be prepared through the use of an organic solvent similar to that in the above-described magnetic layer with the same level of amount of addition.

Preferably, the thickness of the non-magnetic layer is 2.5 μm or less, and more preferably is 0.1 to 2.3 μm. Even when the thickness exceeds 2.5 μm, any improvement of the performance cannot be expected. Contrarily, when the coating film is provided, the thickness tends to become uneven, the coating condition becomes severe, and the surface smoothness tends to become deteriorated.

If necessary, the back coating layer is provided in order to improve the running stability, to prevent the charging of the magnetic layer, and the like. Preferably, the back coating layer contains 30 to 80 percent by mass of carbon black. Any type of usually available carbon black may be used as the above-described carbon black, and carbon black similar to that used in the above-described non-magnetic layer may be used. In addition to the carbon black, if necessary, non-magnetic inorganic powders, e.g., various abrasives; a dispersing agent, e.g., a surfactant; a higher aliphatic acid; a lubricant, e.g., an aliphatic ester, silicone oil or the like; and other various additives, which are used in the magnetic layer, may be added.

The thickness of the back coating layer (after calendering) is 0.1 to 1.5 μm, and preferably is 0.2 to 0.8 μm. If the thickness exceeds 1.5 μm, friction between a medium sliding contact path and the back coating layer becomes too large and, thereby, the running stability tends to become deteriorated. On the other hand, if less than 0.1 μm, shaving of the coating film of the back coating layer tends to occur during running of the medium.

### EXAMPLES

The present invention will be described below in further detail with reference to the examples. In the following description, “part” refers to “part by mass” and “percent” refers to “percent by mass”.

### Synthetic Example 1

### Resin 1

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 372 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 1 was prepared.

### Synthetic Example 2

### Resin 2

A one-liter three neck flask was supplied with 330 parts of 2,4-tolylene diisocyanate (2,4TDI), 0.4 parts of dibutyltin dilaurate, and 0.24 parts of 2,6-di-tert-butyl-4-methylphenol (BHT), and thereafter, 372 parts of 2-hydroxypropyl acrylate (2HPA) was dropped while the temperature was controlled at 60° C. After the dropping was completed, agitation was performed at 60° C. for 2 hours, and the product was taken out, so that a 2,4TDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of 2,4TDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 2 was prepared.

### Synthetic Example 3

### Resin 3

A one-liter three neck flask was supplied with 319 parts of hexamethylene diisocyanate (HDI), 0.4 parts of dibutyltin dilaurate, and 0.24 parts of 2,6-di-tert-butyl-4-methylphenol (BHT), and thereafter, 372 parts of 2-hydroxypropyl acrylate (2HPA) was dropped while the temperature was controlled at 60° C. After the dropping was completed, agitation was performed at 60° C. for 2 hours, and the product was taken out, so that an HDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of HDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 3 was prepared.

### Synthetic Example 4

### Resin 4

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 372 parts of 2-hydroxyethyl methacrylate (2HEMA) was dropped while the temperature was controlled at 60° C. After the dropping was completed, agitation was performed at 60° C. for 2 hours, and the product was taken out, so that an IPDI-2HEMA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of IPDI-2HEMA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 4 was prepared.

### Synthetic Example 5

### Resin 5

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 710 parts of monohydroxypentaerythritol triacrylate was dropped while the temperature was controlled at 60° C. After the dropping was completed, agitation was performed at 60° C. for 2 hours, and the product was taken out, so that an IPDI-monohydroxypentaerythritol triacrylate adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 470 parts of IPDI-monohydroxypentaerythritol triacrylate adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 5 was prepared.

### Synthetic Example 6

### Resin 6

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 372 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of SOLBIN TAO produced by Nisshin Chemical Industry Co., Ltd., 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 6 was prepared.

### Synthetic Example 7

### Resin 7

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 298 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of IPDI-2HPA adduct prepared as described above was put in. After agitation was performed at 70° C. for 15 hours, disappearance of the characteristic absorption (2,270 cm⁻¹ of the isocyanate group was ascertained in the IR spectrum, and the product was taken out, so that a resin 7 was prepared.

### Synthetic Example 8

### Resin 8

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 322 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 8 was prepared.

### Synthetic Example 9

### Resin 9

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 446 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 528 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 9 was prepared.

### Synthetic Example 10

### Resin 10

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 372 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 68 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 10 was prepared.

### Synthetic Example 11

### Resin 11

A one-liter three neck flask was supplied with 330 parts of 2,4-tolylene diisocyanate (2,4TDI), 0.4 parts of dibutyltin dilaurate, and 0.24 parts of 2,6-di-tert-butyl-4-methylphenol (BHT), and thereafter, 372 parts of 2-hydroxypropyl acrylate (2HPA) was dropped while the temperature was controlled at 60° C. After the dropping was completed, agitation was performed at 60° C. for 2 hours, and the product was taken out, so that a 2,4TDI-2HPA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 68 parts of 2,4TDI-2HPA adduct prepared as described above was put in. After agitation was performed at 70° C. for 15 hours, disappearance of the characteristic absorption (2,270 cm⁻¹ of the isocyanate group was ascertained in the IR spectrum, and the product was taken out, so that a resin 11 was prepared.

### Synthetic Example 12

### Resin 12

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 372 parts of 2-hydroxyethyl methacrylate (2HEMA) was dropped while the temperature was controlled at 60° C. After the dropping was completed, agitation was performed at 60° C. for 2 hours, and the product was taken out, so that an IPDI-2HEMA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 68 parts of IPDI-2HEMA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 12 was prepared.

### Synthetic Example 13

### Resin 13

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 298 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 68 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 13 was prepared.

### Synthetic Example 14

### Resin 14

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 322 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-tert-butyl-4-methylphenol (BHT) were put in. After agitation was performed at 70° C. for 3 hours, 68 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 14 was prepared.

### Synthetic Example 15

### Resin 15

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 446 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 68 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 15 was prepared.

### Synthetic Example 16

### Resin 16

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 248 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 16 was prepared.

### Synthetic Example 17

### Resin 17

A one-liter three neck flask was supplied with 330 parts of 2,4-tolylene diisocyanate (2,4TDI), 0.4 parts of dibutyltin dilaurate, and 0.24 parts of 2,6-di-tert-butyl-4-methylphenol (BHT), and thereafter, 248 parts of 2-hydroxypropyl acrylate (2HPA) was dropped while the temperature was controlled at 60° C. After the dropping was completed, agitation was performed at 60° C. for 2 hours, and the product was taken out, so that a 2,4TDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 352 parts of 2,4TDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 17 was prepared.

### Synthetic Example 18

### Resin 18

A one-liter three neck flask was supplied with 348 parts of tolylene diisocyanate (TDI), 0.4 parts of dibutyltin dilaurate, and 0.24 parts of 2,6-di-tert-butyl-4-methylphenol (BHT), and thereafter, 260 parts of 2-hydroxyethyl methacrylate (2HEMA) was dropped while the temperature was controlled at 60° C. After the dropping was completed, agitation was performed at 60° C. for 2 hours, and the product was taken out, so that a TDI-2HEMA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 272 parts of TDI-2HEMA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 18 was prepared.

### Synthetic Example 19

### Resin 19

A three-liter three neck flask was supplied with 500 parts of MR110 produced by ZEON Corporation, 1,250 parts of methyl ethyl ketone (MEK), 0.5 parts of dibutyltin dilaurate, and 0.3 parts of hydroquinone. After agitation was performed at 70° C. for 3 hours, 25 parts of 2-isocyanate ethyl methacrylate was put in. After agitation was performed at 70° C. for 15 hours, disappearance of the characteristic absorption (2,270 cm⁻¹) of the isocyanate group was ascertained in the IR spectrum, and the product was taken out, so that a resin 19 was prepared.

### Synthetic Example 20

### Resin 20

A three-liter three neck flask was supplied with 500 parts of MR110 produced by ZEON Corporation, 725 parts of methyl ethyl ketone (MEK), and 725 parts of toluene. After agitation was performed at 80° C. for 3 hours, 21 parts of 1,2-cyclohexanedicaboxylic anhydride was added. Subsequently, reaction was effected at 80° C. until the characteristic absorption (1,790 cm⁻¹ and 1,870 cm⁻¹) of the acid anhydride disappeared in the IR spectrum. Furthermore, 42 parts of 1,2-cyclohexanedicaboxylic anhydride, 58 parts of glycidyl methacrylate, 0.05 parts of hydroquinone, and 0.3 parts of triethanolamine were gradually added. After agitation was performed at 80° C. for 20 hours, it was ascertained that the acid value became less than 4, and the product was taken out, so that a resin 20 was prepared.

### Synthetic Example 21

### Resin 21

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 496 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of MR110 produced by ZEON Corporation, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 528 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 21 was prepared.

### Synthetic Example 22

### Resin 22

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 248 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 68 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 22 was prepared.

### Synthetic Example 23

### Resin 23

A one-liter three neck flask was supplied with 424 parts of isophorone diisocyanate (IPDI), 0.4 parts of dibutyltin dilaurate, and 0.24 parts of 2,6-di-tert-butyl-4-methylphenol (BHT), and thereafter, 496 parts of 2-hydroxypropyl acrylate (2HPA) was dropped while the temperature was controlled at 60° C. After the dropping was completed, agitation was performed at 60° C. for 2 hours, and the product was taken out, so that an IPDI-2HPA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 68 parts of IPDI-2HPA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 23 was prepared.

### Synthetic Example 24

### Resin 24

A three-liter three neck flask was supplied with 500 parts of Estane 5778P produced by BF GOODRICH, 1,250 parts of methyl ethyl ketone (MEK), 0.5 parts of dibutyltin dilaurate, and 0.3 parts of hydroquinone. After agitation was performed at 70° C. for 3 hours, 25 parts of 2-isocyanate ethyl methacrylate was put in. After agitation was performed at 70° C. for 15 hours, disappearance of the characteristic absorption (2,270 cm⁻¹) of the isocyanate group was ascertained in the IR spectrum, and the product was taken out, so that a resin 24 was prepared.

### Synthetic Example 25

### Resin 25

A one-liter three neck flask was supplied with 348 parts of tolylene diisocyanate (TDI), 0.4 parts of methylphenol (BHT), and thereafter, 260 parts of 2-hydroxyethyl methacrylate (2HEMA) was dropped while the temperature was controlled at 60° C. After the dropping was completed, agitation was performed at 60° C. for 2 hours, and the product was taken out, so that a TDI-2HEMA adduct was prepared.

Subsequently, 630 parts of Estane 5778P produced by BF GOODRICH, 2,291 parts of methyl ethyl ketone (MEK), 2.45 parts of dibutyltin dilaurate, and 0.09 parts of 2,6-di-tert-butyl-4-methylphenol (BHT) were put in. After agitation was performed at 70° C. for 3 hours, 68 parts of TDI-2HEMA adduct prepared as described above was put in. After agitation was performed at 70° C. for 15 hours, disappearance of the characteristic absorption (2,270 cm⁻¹) of the isocyanate group was ascertained in the IR spectrum, and the product was taken out, so that a resin 25 was prepared.

### Example 1

(Evaluation 1) Evaluation of Cross-Linking Property

A coating of the resin 1 of 30 μm in thickness was formed on a release film and, thereafter, 6 Mrad of electron beam was applied under the condition of an acceleration voltage of 200 kV, so that the coating was cured. Subsequently, the resin coating after subjected to the electron beam curing was peeled off the release film, and the gel ratio was measured under the following condition.

<Gel Ratio Measurement Condition>

solvent: methyl ethyl ketone (MEK)

extraction condition: MEK boiling

extraction time: 5 hours

Extraction was performed under the above-described condition, the weight of the resin coating was measured before and after the extraction, and the gel ratio was calculated from the difference between the weights.

(Evaluation 2) Evaluation of Cross-Linking Property and Dispersibility of Coating Containing Pigment or Magnetic Powder

With respect to three types of system including a magnetic metal powder, an α-iron oxide/carbon black mixture, and carbon black, evaluation of the solvent resistance was performed as the evaluation of cross-linking property of each sample in which any one of the systems was dispersed in a resin and cross-linking was effected. In addition, the surface roughness (Ra) was measured in order to evaluate the dispersibility.

(1) Evaluation of Magnetic Metal Powder

Preparation of magnetic paint sample

| | |
|---|---|
| magnetic metal powder (Fe/Co/Al/Y = 100/10/5.2/2.0 | 100 parts |
| (weight ratio)) | |
| (Hc = 145.6 kA/m (1,830 Oe), σs = 130 Am²/kg, BET | |
| specific surface area = 57 m²/g, average major-axis | |
| length = 0.10 μm) | |
| resin 1 | 70 parts |
| MEK | 120 parts |
| toluene | 120 parts |
| cyclohexanone | 70 parts |

The above-described composition was subjected to a kneading treatment and, thereafter, dispersion was performed with a sand grinder mill, so that a magnetic paint was prepared.

The resulting magnetic paint was applied to a polyethylene terephthalate (PET) film of 6.1 μm in thickness in order that the thickness after drying became 1.5 μm. After drying was performed at a drying temperature of 100° C., a calender treatment was performed at a linear pressure of 2.9×10⁵ N/m and a temperature of 90° C. Subsequently, electron beam (EB) irradiation (6 Mrad) was performed, so that a cured coating of the magnetic paint was prepared.

(2) Evaluation of α-Iron Oxide/Carbon Black Mixture System Pigment

Preparation of non-magnetic paint sample

| | |
|---|---|
| non-magnetic powder: acicular α-Fe₂O₃ | 80 parts |
| (average minor-axis diameter = 18 nm, aspect ratio = 6.1, | |
| pH = 8.9) | |
| carbon black (#850B: produced by MITSUBISHI | 20 parts |
| CHEMICAL CORPORATION) | |
| (average particle diameter = 16 nm, BET specific surface | |
| area = 200 m²/g, DBP oil absorption = 70 ml/100 g) | |
| resin 1 | 70 parts |
| MEK | 120 parts |
| toluene | 120 parts |
| cyclohexanone | 70 parts |

The above-described composition was subjected to a kneading treatment and, thereafter, dispersion was performed with a sand grinder mill, so that a non-magnetic paint was prepared.

The resulting non-magnetic paint was applied to a PET film of 6.1 μm in thickness in order that the thickness after drying became 1.5 μm. After drying was performed at a drying temperature of 100° C., a calender treatment was performed at a linear pressure of 2.9×10⁵ N/m and a temperature of 90° C. Subsequently, EB irradiation (6 Mrad) was performed, so that a cured coating of the non-magnetic paint was prepared.

(3) Evaluation of Carbon Black System

Preparation of carbon black paint sample

| | |
|---|---|
| carbon black | 100 parts |
| (Conductex SC: produced by Columbian Carbon, average | |
| particle diameter = 20 nm, BET specific surface | |
| area = 220 m²/g) | |
| carbon black | 1 part |
| (Sevacarb MT: produced by Columbian Carbon, average | |
| particle diameter = 350 nm, BET specific surface | |
| area = 8 m²/g) | |
| resin 1 | 330 parts |
| MEK | 350 parts |
| toluene | 350 parts |
| cyclohexanone | 170 parts |

The above-described composition was subjected to a kneading treatment and, thereafter, dispersion was performed with a sand grinder mill.

The resulting carbon black paint was applied to a PET film of 6.1 μm in thickness in order that the thickness after drying became 1.5 μm. After drying was performed at a drying temperature of 100° C., a calender treatment was performed at a linear pressure of 2.9×10⁵ N/m and a temperature of 70° C. Subsequently, EB irradiation (6 Mrad) was performed, so that a cured coating of the carbon black paint was prepared.

With respect to each coating sample prepared by the above-described method, the solvent resistance was evaluated based on the following method and criteria.

(a) An MEK-impregnated cotton swab was used.

(b) The cotton swab was rubbed against the surface of the coating.

(c) The number of rubbing required to eliminate the coating was counted.

(d) Criteria (the number of rubbing)

at least 15: ⊙

10 or more and less than 15: ◯

5 or more and less than 10: Δ

1 or more and less than 5: x

In order to evaluate the surface roughness, the measurement was performed under the following condition.

measurement device: Talystep System produced by Taylor Hobson K.K.

measurement condition:

filter condition: 0.18 to 9 Hz

probe: 0.1×2.5 μm specific stylus

probe load: 2 mg

measurement speed: 0.03 mm/sec

measurement length: 500 μm

### Example 2

A coating sample was prepared and evaluated as in Example 1 except that the resin 2 was used in place of the resin 1 in Example 1.

### Example 3

A coating sample was prepared and evaluated as in Example 1 except that the resin 3 was used in place of the resin 1 in Example 1.

### Example 4

A coating sample was prepared and evaluated as in Example 1 except that the resin 4 was used in place of the resin 1 in Example 1.

### Example 5

A coating sample was prepared and evaluated as in Example 1 except that the resin 5 was used in place of the resin 1 in Example 1.

### Example 6

A coating sample was prepared and evaluated as in Example 1 except that the resin 6 was used in place of the resin 1 in Example 1.

### Example 7

A coating sample was prepared and evaluated as in Example 1 except that the resin 7 was used in place of the resin 1 in Example 1.

### Example 8

A coating sample was prepared and evaluated as in Example 1 except that the resin 8 was used in place of the resin 1 in Example 1.

### Example 9

A coating sample was prepared and evaluated as in Example 1 except that the resin 9 was used in place of the resin 1 in Example 1.

### Example 10

A coating sample was prepared and evaluated as in Example 1 except that the resin 10 was used in place of the resin 1 in Example 1.

### Example 11

A coating sample was prepared and evaluated as in Example 1 except that the resin 11 was used in place of the resin 1 in Example 1.

### Example 12

A coating sample was prepared and evaluated as in Example 1 except that the resin 12 was used in place of the resin 1 in Example 1.

### Example 13

A coating sample was prepared and evaluated as in Example 1 except that the resin 13 was used in place of the resin 1 in Example 1.

### Example 14

A coating sample was prepared and evaluated as in Example 1 except that the resin 14 was used in place of the resin 1 in Example 1.

### Example 15

A coating sample was prepared and evaluated as in Example 1 except that the resin 15 was used in place of the resin 1 in Example 1.

### Comparative Example 1

A coating sample was prepared and evaluated as in Example 1 except that the resin 16 was used in place of the resin 1 in Example 1.

### Comparative Example 2

A coating sample was prepared and evaluated as in Example 1 except that the resin 17 was used in place of the resin 1 in Example 1.

### Comparative Example 3

A coating sample was prepared and evaluated as in Example 1 except that the resin 18 was used in place of the resin 1 in Example 1.

### Comparative Example 4

A coating sample was prepared and evaluated as in Example 1 except that the resin 19 was used in place of the resin 1 in Example 1.

### Comparative Example 5

A coating sample was prepared and evaluated as in Example 1 except that the resin 20 was used in place of the resin 1 in Example 1. Comparative Example 6

A coating sample was prepared and evaluated as in Example 1 except that the resin 21 was used in place of the resin 1 in Example 1.

### Comparative Example 7

A coating sample was prepared and evaluated as in Example 1 except that the resin 22 was used in place of the resin 1 in Example 1.

### Comparative Example 8

A coating sample was prepared and evaluated as in Example 1 except that the resin 23 was used in place of the resin 1 in Example 1.

### Comparative Example 9

A coating sample was prepared and evaluated as in Example 1 except that the resin 24 was used in place of the resin 1 in Example 1.

### Comparative Example 10

A coating sample was prepared and evaluated as in Example 1 except that the resin 25 was used in place of the resin 1 in Example 1.

### Comparative Example 11

A resin solution 1 was prepared by dissolving 300 g of MR110 produced by ZEON Corporation into 700 g of methyl ethyl ketone (MEK). A coating sample was prepared and evaluated as in Example 1 except that the above-described resin solution 1 was used in place of the resin 1 in the Example.

### Comparative Example 12

A resin solution 2 was prepared by dissolving 300 g of Estane 5778P produced by BF GOODRICH into 700 g of methyl ethyl ketone (MEK). A coating sample was prepared and evaluated as in Example 1 except that the above-described resin solution 2 was used in place of the resin 1 in Example 1.

The resins, diisocyanates (DI), hydoxy(meth)acrylate compounds (HA), and HA/DI molar ratios in synthesis of DI-HA adducts, which were used in Examples 1 to 15 and Comparative examples 1 to 12, are collectively shown in the following Table 1. The evaluation results are shown in the following Tables 2 to 5.

TABLE 1

| | | Diisocyanate | Hydroxyacrylate | HA/DI | |
|---|---|---|---|---|---|
| | Resin No. | (DI) | compound (HA) | molar ratio | Resin |
| Example 1 | 1 | IPDI | HPA | 1.5 | Vinyl chloride (MR110) |
| Example 2 | 2 | TDI | HPA | 1.5 | Vinyl chloride (MR110) |
| Example 3 | 3 | HDI | HPA | 1.5 | Vinyl chloride (MR110) |
| Example 4 | 4 | IPDI | 2HEMA | 1.5 | Vinyl chloride (MR110) |
| Example 5 | 5 | IPDI | Pentaerythritol | 1.5 | Vinyl chloride (MR110) |
| Example 6 | 6 | IPDI | HPA | 1.5 | Vinyl chloride (SOLBIN) |
| Example 7 | 7 | IPDI | HPA | 1.2 | Vinyl chloride (MR110) |
| Example 8 | 8 | IPDI | HPA | 1.3 | Vinyl chloride (MR110) |
| Example 9 | 9 | IPDI | HPA | 1.8 | Vinyl chloride (MR110) |
| Example 10 | 10 | IPDI | HPA | 1.5 | Polyurethane (Estane) |
| Example 11 | 11 | TDI | HPA | 1.5 | Polyurethane (Estane) |
| Example 12 | 12 | IPDI | 2HEMA | 1.5 | Polyurethane (Estane) |
| Example 13 | 13 | IPDI | HPA | 1.2 | Polyurethane (Estane) |
| Example 14 | 14 | IPDI | HPA | 1.3 | Polyurethane (Estane) |
| Example 15 | 15 | IPDI | HPA | 1.8 | Polyurethane (Estane) |
| Comparative | 16 | IPDI | HPA | 1 | Vinyl chloride (MR110) |
| example 1 | | | | | |
| Comparative | 17 | TDI | HPA | 1 | Vinyl chloride (MR110) |
| example 2 | | | | | |
| Comparative | 18 | TDI | 2HEMA | 1 | Vinyl chloride (MR110) |
| example 3 | | | | | |
| Comparative | 19 | MOI | — | — | Vinyl chloride (MR110) |
| example 4 | | | | | |
| Comparative | 20 | Ester | — | — | Vinyl chloride (MR110) |
| example 5 | | modification | | | |
| Comparative | 21 | IPDI | HPA | 2 | Vinyl chloride (MR110) |
| example 6 | | | | | |
| Comparative | 22 | IPDI | HPA | 1 | Polyurethane (Estane) |
| example 7 | | | | | |
| Comparative | 23 | IPDI | HPA | 2 | Polyurethane (Estane) |
| example 8 | | | | | |
| Comparative | 24 | MOI | — | — | Polyurethane (Estane) |
| example 9 | | | | | |
| Comparative | 25 | TDI | 2HEMA | 1 | Polyurethane (Estane) |
| example 10 | | | | | |
| Comparative | Resin | — | — | — | — |
| example 11 | solution 1 | | | | |
| Comparative | Resin | — | — | — | — |
| example 12 | solution 2 | | | | |

TABLE 2

| | | Example 1 | Example 2 | Example 3 | Example 4 | Example 5 | Example 6 | Example 7 | Example 8 |
|---|---|---|---|---|---|---|---|---|---|
| Resin | | Resin 1 | Resin 2 | Resin 3 | Resin 4 | Resin 5 | Resin 6 | Resin 7 | Resin 8 |
| Gel ratio (%) | | 95 | 85 | 86 | 94 | 98 | 96 | 86 | 93 |
| Solvent | Magnetic | ⊚ | ◯ | ◯ | ⊚ | ⊚ | ⊚ | ◯ | ⊚ |
| resistance | paint coating | | | | | | | | |
| | Non-magnetic | ⊚ | ◯ | ◯ | ⊚ | ⊚ | ⊚ | ◯ | ⊚ |
| | paint coating | | | | | | | | |
| | Carbon paint | ⊚ | ◯ | ◯ | ⊚ | ⊚ | ⊚ | ◯ | ⊚ |
| | coating | | | | | | | | |
| Surface | Magnetic | 4.5 | 5.5 | 5.6 | 4.6 | 5.0 | 5.5 | 5.2 | 4.7 |
| roughness | paint coating | | | | | | | | |
| Ra (nm) | Non-magnetic | 3.6 | 4.4 | 4.8 | 3.4 | 4.0 | 4.0 | 4.5 | 3.8 |
| | paint coating | | | | | | | | |
| | Carbon paint | 9.0 | 14.0 | 15.5 | 9.0 | 11.0 | 10.5 | 12.3 | 10.5 |
| | coating | | | | | | | | |

TABLE 3

| | | Example | Example | Example | Example | Example | Example | Example |
|---|---|---|---|---|---|---|---|---|
| | | 9 | 10 | 11 | 12 | 13 | 14 | 15 |
| Resin | | Resin 9 | Resin 10 | Resin 11 | Resin 12 | Resin 13 | Resin 14 | Resin 15 |
| Gel ratio (%) | | 88 | 90 | 83 | 89 | 82 | 89 | 82 |
| Solvent | Magnetic | ◯ | ⊚ | ◯ | ⊚ | ◯ | ⊚ | ◯ |
| resistance | paint coating | | | | | | | |
| | Non-magnetic | ◯ | ⊚ | ◯ | ⊚ | ◯ | ⊚ | ◯ |
| | paint coating | | | | | | | |
| | Carbon paint | ◯ | ⊚ | ◯ | ⊚ | ◯ | ⊚ | ◯ |
| | coating | | | | | | | |
| Surface | Magnetic | 4.6 | 4.6 | 5.7 | 5.0 | 5.1 | 4.7 | 4.7 |
| roughness | paint coating | | | | | | | |
| Ra (nm) | Non-magnetic | 3.7 | 4.3 | 4.8 | 4.3 | 4.6 | 4.4 | 4.8 |
| | paint coating | | | | | | | |
| | Carbon paint | 9.8 | 9 | 14.5 | 11.2 | 11.0 | 9.7 | 10.2 |
| | coating | | | | | | | |

TABLE 4

| | | Comparative | Comparative | Comparative | Comparative | Comparative | Comparative |
|---|---|---|---|---|---|---|---|
| | | example 1 | example 2 | example 3 | example 4 | example 5 | example 6 |
| Resin | | Resin 16 | Resin 17 | Resin 18 | Resin 19 | Resin 20 | Resin 21 |
| Gel ratio (%) | | 70 | 61 | 60 | 78 | 76 | 15 |
| Solvent | Magnetic | X | X | X | Δ | Δ | X |
| resistance | paint coating | | | | | | |
| | Non-magnetic | X | X | X | Δ | Δ | X |
| | paint coating | | | | | | |
| | Carbon paint | X | X | X | Δ | Δ | X |
| | coating | | | | | | |
| Surface | Magnetic | 7.9 | 8.0 | 8.2 | 6.0 | 9.6 | 4.6 |
| roughness | paint coating | | | | | | |
| Ra (nm) | Non-magnetic | 7.8 | 8.9 | 8.7 | 6.5 | 8.6 | 4.1 |
| | paint coating | | | | | | |
| | Carbon paint | 21.0 | 22.0 | 22.0 | 18.4 | 30.0 | 10.2 |
| | coating | | | | | | |

TABLE 5

| | | Comparative | Comparative | Comparative | Comparative | Comparative | Comparative |
|---|---|---|---|---|---|---|---|
| | | example 7 | example 8 | example 9 | example 10 | example 11 | example 12 |
| Resin | | Resin 22 | Resin 23 | Resin 24 | Resin 25 | Resin | Resin |
| | | | | | | solution 1 | solution 2 |
| Gel ratio (%) | | 55 | 8 | 20 | 10 | 0 | 0 |
| Solvent | Magnetic | X | X | X | X | X | X |
| resistance | paint coating | | | | | | |
| | Non-magnetic | X | X | X | X | X | X |
| | paint coating | | | | | | |
| | Carbon paint | X | X | X | X | X | X |
| | coating | | | | | | |
| Surface | Magnetic | 7.6 | 4.8 | 4.7 | 5.2 | 4.4 | 4.5 |
| roughness | paint coating | | | | | | |
| Ra (nm) | Non-magnetic | 8.2 | 4.3 | 3.9 | 4.9 | 3.7 | 4.2 |
| | paint coating | | | | | | |
| | Carbon paint | 22.0 | 10.5 | 10.5 | 10.4 | 9.5 | 9.4 |
| | coating | | | | | | |

What is claimed is:

1. An electron beam curing resin for a magnetic recording medium, comprising a product resulting from a reaction between DI-HA adducts and active hydrogen groups of a vinyl chloride resin or polyurethane resin having the active hydrogen groups in a molecule, wherein the DI-HA adduct is a product resulting from a reaction between a diisocyanate (DI) and a hydoxy(meth)acrylate compound (HA) at an HA/DI molar ratio of more than 1 and less than 2.

2. The electron beam curing resin for a magnetic recording medium according to claim 1, wherein the diisocyanate (DI) is isophorone diisocyanate (IPDI).

3. A method for manufacturing an electron beam curing resin for a magnetic recording medium, comprising the steps of:
reacting a diisocyanate (DI) and a hydoxy(meth)acrylate compound (HA) at an HA/DI molar ratio of more than 1 and less than 2; and
reacting the resulting DI-HA adducts and a vinyl chloride resin or polyurethane resin having active hydrogen groups in a molecule.

4. A magnetic recording medium comprising a layer containing an electron beam curing resin for a magnetic recording medium on a non-magnetic support, the electron beam curing resin being a product resulting from a reaction between DI-HA adducts and active hydrogen groups of a vinyl chloride resin or polyurethane resin having the active hydrogen groups in a molecule, wherein the DI-HA adduct is a product resulting from a reaction between a diisocyanate (DI) and a hydroxy(meth)acrylate compound (HA) at an HA/DI molar ratio of more than 1 and less than 2.

5. The magnetic recording medium according to claim 4, wherein the diisocyanate (DI) is isophorone diisocyanate (IPDI).
